(19) United States
(12) Patent Application Publication
(10) Pub. No.: US 2009/0225768 A1
(43) Pub. Date: Sep. 10, 2009

(54) CENTRALIZED TS PACKET BUFFER MANAGEMENT IN MULTIPLE TRANSPORT STREAM MPEG-2 DEMUX

(75) Inventors: Shih-Ta Hsu, Tainan (TW); Bo-Ting Lin, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 12/043,824

(22) Filed: Mar. 6, 2008

(51) Int. Cl. H04L 12/56

(52) U.S. Cl. 370/412

(57) ABSTRACT

A de-multiplexer is disclosed. A transport stream de-multiplexer includes a plurality of input buffers (211-21N) each receiving bytes from a plurality of packets in a corresponding transport stream, a main buffer (230) for temporal storage of said packets and an input arbiter temporally allotting a space of at least one packet in the main buffer to one of said packets when receiving a request to store a first byte of said packets into said main buffer.

### BACKGROUND

I. Field of the Invention

The present invention relates generally to the field of MPEG-2 de-multiplexer system, and more particularly to a buffer system designed within a MPEG-2 de-multiplexer system.

II. Background of the Invention

Digital television is becoming more popular due to its high video and audio quality. Currently most digital television content providers adopt MPEG-2 specification to encode and compress their data signals and transmit/broadcast the encoded data signals from the header end, e.g., television broadcasting station, to the client ends, e.g., television sets. A MPEG-2 encoding process begins with compressing the video and audio data respectively, and then uses a multiplexer to mix these encoded video and audio data signals to form a plurality of transport streams.

At the receiving end of the signal, e.g., the client end or television set end, there is a de-multiplexer to receive the plurality of transport streams from the header end. The de-multiplexer will divide the contents of the plurality of transport streams into encoded video data signals and encoded audio data signals in a reverse order from the multiplexing process. The divided encoded video and audio data signals will be sent to a video and audio decoder, respectively, for further processing.

FIG. 1 is a block diagram that illustrates a conventional multiple transport streams MPEG-2 de-multiplexer (DEMUX) system.

As shown in FIG. 1, the MPEG-2 de-multiplexer system includes a plurality of data input buffers (111, 112, . . . 11N), wherein each plurality of data input buffers has a predetermined physical size for temporally storing each transport stream data, a multiplexer 120 allowing only one transport stream data to pass though at a given time and a plurality of data output buffers (131, 132, . . . 13M) for further delivering each transport stream data to a corresponding destination. The plurality of data input buffers can be any type of storage system, such as a first-in-first-out (FIFO) or the like.

Due to the bit rate inconsistency between transport stream and de-multiplexer, there is a need to have a transport stream buffer to temporally store un-processed transport stream packet in a de-multiplexer system. For those processing multiple transport streams de-multiplexer systems, there is a need to use a large buffer space in order to meet the demand of multiple write in. In addition, upon processing the input of the plurality of transport streams with various bit rates, how to effectively allocate and release the transport stream buffer space has become a challenge in a de-multiplexer system design.

It is difficult to properly estimate the bit rate of each transport stream and maintain the efficiency of each data input buffer storage space at either full or low utilization rate in the conventional MPEG-2 de-multiplex system design. First, to accommodate all possible transport stream bit rates, the storage space of each data input buffers must be designed at their worst conditions. That is, the designer must ensure that each data input buffer space is as large as possible in order not to miss any transport stream packets if the corresponding transport stream of the data input buffer has a higher bit rate and the multiplexer 120 is not able to deliver the high bit rate transport stream packets to their corresponding destinations in time.

Therefore, there is a need for a centralized transport stream (TS) packet buffer management system in a multiple transport stream MPEG-2 de-multiplexer (DEMUX) that can solve or improve the above-mentioned drawbacks.

### SUMMARY OF THE INVENTION

Systems, methods, and apparatuses for an improved MPEG-2 de-multiplexer system are disclosed. In order to overcome the disadvantages of the conventional method, the present invention provides an improved MPEG-2 de-multiplexer system featuring a new architecture and a better buffer space utilization capability.

In one aspect, a de-multiplexer is disclosed. A transport stream de-multiplexer includes a plurality of input buffers (211-21N) each receiving bytes of a packet in a corresponding transport stream, a main buffer (230) for temporal storage of said packets and an input arbiter temporally allotting a space of at least one packet in the main buffer to one of said packets when receiving a request for storing a first byte of said packet into said main buffer.

In another aspect, a method of transmitting packets in a transport stream de-multiplexer system is disclosed. The method comprises the following steps. First, a plurality of packets of transport streams enters into a plurality of corresponding input buffers (211-21N). Second, said plurality of packets within said plurality of input buffers is sent to a main buffer (230) sequentially, regulated by an input arbiter (220). And thirdly, said plurality of packets within said main buffer is sent to a plurality of output buffers (271-27M) sequentially, regulated by an output queue (260).

Some advantages of the present invention are: (1) a centralized buffer space to better accommodate transport streams with various bit rates; (2) an one write-in and one read-out SRAM can better save the buffer area; and (3) a target table to record the destination information of different packets, allowing a packet to be sent to more than one destination. These and other features, aspects, and embodiments of the invention are described below in the section entitled “Detailed Description.”

### BRIEF DESCRIPTION OF THE DRAWINGS

The accompanying drawings, which are incorporated in and constitute part of this specification, illustrate various embodiments of the invention and together with the description serve to explain the principles of the invention.

FIG. 1 illustrates a schematic diagram of a conventional MPEG-2 de-multiplex system.

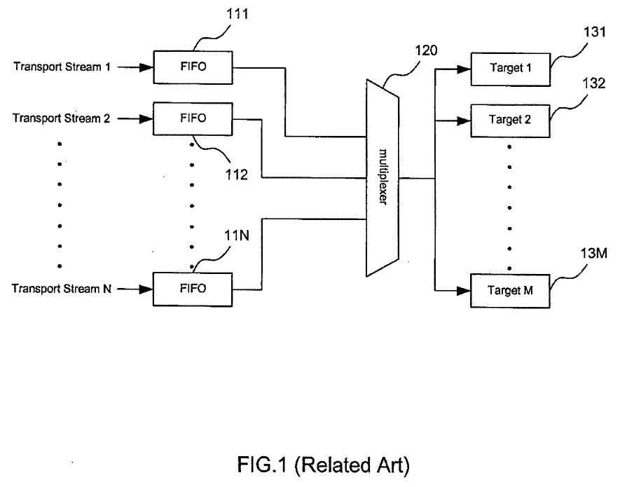

FIG. 2 illustrates a schematic diagram of a proposed MPEG-2 de-multiplexer system featuring a centralized transport stream packet buffer in accordance with one embodiment of the present invention.

### DETAILED DESCRIPTION

Reference is made in detail to embodiments of the invention. While the invention is described here in terms of embodiments, the invention is not intended to be limited to just these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, as is obvious to one of ordinary skilled in the art, the invention may be practiced without these specific details. In other instances, well-known methods, procedures, components, and circuits have not been described in detail such that the primary aspects of the invention will not be obscured.

One embodiment of the present invention disclose a multiple transport stream MPEG-2 de-multiplexer (DEMUX) system having a centralized transport stream packet buffer featuring a new architecture, and having a better buffer space utilization capability. The proposed multiple transport streams MPEG-2 de-multiplexer system comprises a plurality of input buffers (211-21N), an input arbiter 220, a packet ID (PID) filter 240, a target table 250, a main buffer 230, an output queue 260 and a plurality of output buffers (271-27M).

### Embodiment

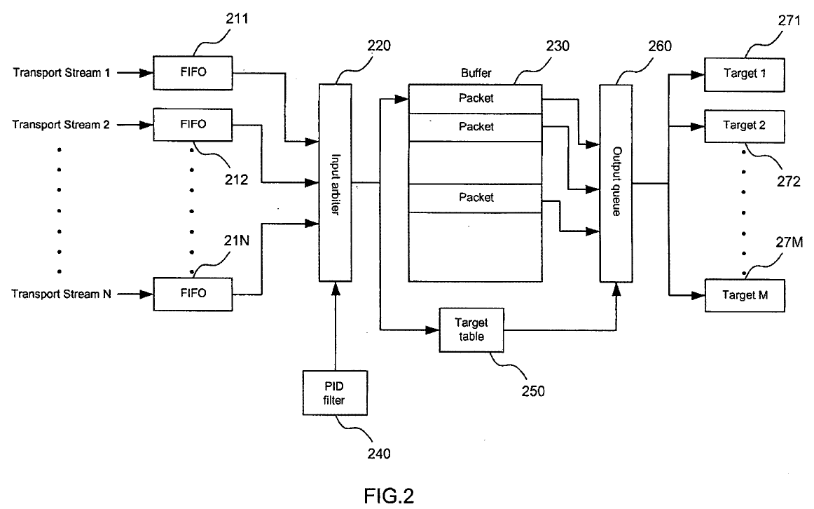

In FIG. 2, a schematic diagram illustrates a proposed MPEG-2 de-multiplexer system featuring a centralized transport stream packet buffer in accordance with one embodiment of the present invention.

As shown in FIG. 2, the proposed MPEG-2 de-multiplexer system includes the following functional blocks. A plurality of input buffers (211-21N), wherein each said plurality of input buffers has a predetermined physical size for temporally storing each transport stream data, e.g., a transport stream packet. The size of the plurality of input buffers must be able to cover an arbitration latency time when waiting for a next available permission from the input arbiter 220 to deliver transport stream data of the input buffer into the main buffer 230. In the embodiment, the size requirement is approximately several bytes. The plurality of input buffers (211-21N) can be any type of storage system, such as a first-in-first-out (FIFO) or the like.

Upon the plurality of input buffers (211-21N) receiving a first byte of the transport stream packets, the buffers that received the packet will send a request to the input arbiter 220, respectively, in order to write their transport stream packets into the main buffer 230. The input arbiter 220 will follow a pre-determined priority to deliver the transport stream packets and store the packet in the main buffer 230. The input arbiter 220 will temporally allot a space of at least one packet in the main buffer 230 to one of the packets when receiving a request to store a first byte of the packet into the main buffer 230. In the embodiment, the allotted space for a packet is 188 bytes.

The input arbiter 220 will query the PID filter 240 with the packet ID and the source of transport stream packet of the received transport stream packet. The packet ID filter 240 will notify the input arbiter 220 whether the queried packet is in the allowed list or not. If the queried packet is allowed, the input arbiter 220 will keep delivering the remaining bytes of the packet to the main buffer 230. The packet ID filter 240 will further notify the input arbiter 220 with destination information of the allowed transport stream packets. The allowed packet ID list and destination information within the packet ID filter 240 can be programmed and updated by a computer. If the queried packet is not an allowed packet, the packet will be dropped by the input arbiter 220 immediately.

The selected packets are sequentially stored into the main buffer 230 according to their priorities decided by the input arbiter 220. The priority information stored within the input arbiter 220 that corresponds to each packet can be programmed and updated by a computer. The input arbiter 220 will notify the target table 250 with the destination information corresponding to each stored packets. In another embodiment, the packet ID filter 240 only notifies the input arbiter 220 with the allowed/reject information of each packet and the packet ID filter 240 will directly notify the target table 250 with destination information of each packet. The main buffer 230 can be any type of storage system, such as a one write-in and one read-out static random access memory (SRAM) or the like.

When a packet is completely stored in the main buffer 230, the output queue 260 is prepared to output the packet to a designated destination. The target table 250 will provide destination information corresponding to each stored packets to the output queue 260. In the embodiment, the output queue 260 is able to output the packet to more than one of the plurality of output buffers (271-27M).

The plurality of output buffers (271-27M) will further deliver each transport stream packet to a corresponding destination, e.g., a video decoder, an audio decoder, a parser, a direct memory access (DMA) or a POD, et. al.

The advantages of the embodiment described above are as follows. (1) A centralized buffer space to better accommodate transport streams with various bit rates. (2) A one write-in and one read-out SRAM can better save the buffer area. (3) A target table to record the destination information of different packets and to allow a packet to be sent to more than one destination.

Although the embodiment of the invention is illustrated by SRAM, it is not intended to limit thereto. Other types of storage system can be implemented according to the invention.

While the invention has been described with reference to various illustrative embodiments, the description is not intended to be construed in a limiting sense. The appended claims will cover any modifications or embodiments as may fall within the scope of the present invention.

What is claimed is:

1. A transport stream de-multiplexer comprising:
a plurality of input buffers each receiving bytes from a plurality of packets in a corresponding transport stream;
a main buffer for temporary storage of said plurality of packets; and
an input arbiter temporarily allotting a space of at least one packet in the main buffer to one of said plurality of packets when receiving a request to store a first byte of said plurality of packets into said main buffer.

2. The transport stream de-multiplexer as claimed in claim 1 further comprising:
a plurality of output buffers each receiving bytes from said plurality of packets intended for their corresponding targets; and
an output queue sequentially transferring said plurality of packets in said main buffer to said output buffers according to said targets which said plurality of packets are intended for.

3. The transport stream de-multiplexer as claimed in claim 1, further comprising a target table that records a destination information of every packet passing through said input arbiter and that instructs said output queue to dispatch said packet to said appropriate output buffers.

4. The transport stream de-multiplexer as claimed in claim 3, wherein said packet dispatched by said output queue is able to be sent to more than one of said plurality of output buffers.

5. The transport stream de-multiplexer as claimed in claim 1, further comprising a packet filter issuing a selection signal to allow a plurality of selected packets in said transport streams to pass through said input arbiter.

6. The transport stream de-multiplexer as claimed in claim 1, wherein said plurality of input buffers is first-in-first-out (FIFO) buffers.

7. The transport stream de-multiplexer as claimed in claim 1, wherein said input arbiter decides a priority for said plurality of selected packets in said transport streams to pass through said input arbiter.

8. The transport stream de-multiplexer as claimed in claim 1, wherein said main buffer is a one write-in and one read-out static random access memory (SRAM).

9. The transport stream de-multiplexer as claimed in claim 5, wherein said packet filter is a packet ID (PID) filter sending said selection signal to said input arbiter, wherein said selection signal instructs said input arbiter to recognize said plurality of selected packets that is to pass through said input arbiter according to header information of said each packet.

10. The transport stream de-multiplexer as claimed in claim 1, wherein said plurality of output buffers send said plurality of packets to video, audio and/or hard drives.

11. A method of transmitting packets in a transport stream de-multiplexer system, comprising the steps of: inputting a plurality of packets in transport streams to a plurality of corresponding input buffers;
sending said plurality of packets within said plurality of input buffers to a main buffer sequentially regulated by an input arbiter; and
sending said plurality of packets within said main buffer to a plurality of output buffers sequentially regulated by an output queue.

12. The method of claim 11, further comprising in a target table recording a destination information of every packet passing through said input arbiter and instructing said output queue to dispatch said packet to said appropriate output buffers.

13. The method of claim 12, wherein said packet dispatched by said output queue is able to be sent to more than one of said plurality of output buffers.

14. The method of claim 11, further comprising issuing a selection signal from a packet filter to allow a plurality of selected packets in said transport streams to pass through said input arbiter.

15. The method of claim 11, wherein said plurality of input buffers is first-in-first-out (FIFO) buffers.

16. The method of claim 11, wherein said input arbiter decides a priority for said plurality of packets in said transport streams to pass through said input arbiter and allots a space of at least one packet in the main buffer to one of said plurality of packets upon receiving a request to store a first byte of said plurality of packets into said main buffer.

17. The method of claim 11, wherein said main buffer is a one write-in and one read-out static random access memory (SRAM).

18. The method of claim 14, wherein said packet filter is a packet ID (PID) filter sending said selection signal to said input arbiter, wherein said selection signal instructs said input arbiter to recognize said plurality of selected packets that is to pass through said input arbiter according to header information of said each packet.
